(19) United States
(12) Patent Application Publication
(10) Pub. No.: US 2006/0274526 A1
(43) Pub. Date: Dec. 7, 2006

(54) Integrated sign illumination system

(75) Inventors: Adrian Weston, New Westminster (CA); Peter Kan, North Vancouver (CA); Gary Zywiecki, Coquitlam (CA); Dmitry Malakhov, Vancouver (CA)

Correspondence Address: KING & SPALDING LLP, 1180 PEACHTREE STREET, ATLANTA, GA, 30309, US

(73) Assignee: TIR Systems Ltd., Burnaby (CA)

(21) Appl. No.: 11/411,674

(22) Filed: Apr. 26, 2006

Related U.S. Application Data
(60) Provisional application No. 60/737,912, filed on Nov. 18, 2005.

(30) Foreign Application Priority Data
Apr. 26, 2005 (CA) 2.505.834

(51) Int. Cl. F21S 13/14

(52) U.S. Cl. 362/252; 362/293; 362/240

(57) ABSTRACT

The present invention provides an integrated sign illumination system for the illumination of a sign face. The system comprises a contoured mounting device configured for directing a selected colour of light to a selected portion of the sign face. A plurality of light-emitting elements for the generation of light of one or more colours are optically coupled to the contoured mounting system at selected mounting sites. The colour of the light produced by the light emitting elements can be configured to be compatible with the selected illumination colour of the sign face thereby providing a means for the reduction of light loss due to absorption by the sign face.

### CROSS REFERENCE TO RELATED APPLICATIONS

This application claims the benefit of priority to U.S. Provisional Application No. 60/737,912 filed on Nov. 18, 2005 and Canadian Patent Application No. 2,505,834 filed on Apr. 26, 2005.

### FIELD OF THE INVENTION

The present invention pertains to lighting systems for use with signage and in particular to an integrated sign illumination system.

### BACKGROUND

Many companies use illuminated signs to draw attention to their services, for fuel stations and fast food restaurants, for example. Often these signs are multi-coloured and are traditionally illuminated by a full spectrum white light source such as a fluorescent tube, Neon or light emitting diodes (LED). For these white light sources, a large portion of the light energy is wasted through the absorption filtering of the graphic media of the sign being illuminated, wherein through the absorption of undesired wavelengths, an intended colour of light emanates from the sign. This phenomenon can produce a “washed out” or faded look to the colours of the sign face in addition to the waste of light energy.

International Patent Application Publication No. WO 2005/020188 discloses an illuminated street sign wherein the illumination is provided by LEDs. This application describes a light engine comprising a light engine carrier, at least one LED, a heat sink and optionally a reflector and/or lens system to illuminate a street sign. The light engine can be retrofit into existing illuminated street signs after removal of the fluorescent tube or can be attached to the interior of conventional housings or can be integrally formed with the housing of an illuminated sign. A pair of light engines are mounted in the housing at an angle to direct the light to the opposite side panel wherein each light engine has a reflector and an additional reflector can be mounted on the base of the housing. This lighting system is particularly applicable to illuminating street signs and defined as additionally being a fluorescent tube replacement and therefore if this lighting system is used for multicolour or single colour signs the result may be an undesired faded colour appearance of the sign.

United States Patent Application Publication No. 2004/0255497 discloses an illuminated sign or nametag achieving the even glow and brightness of neon light displays without neon light tubes. Each character or symbol of the sign or nametag contains a plurality of light emitting members. Each such character or symbol comprises a light diffusion layer illuminated by light emitting members disposed in a planar manner, on, near or in the light diffusion layer. A permanent or temporary masking layer partially covers the light diffusion layer to form a glowing border around the masking layer. Reflective layers covering either or both faces of the light diffusion layer may be used to intensify the light emitted therefrom. By the particular arrangement of the reflective surfaces relative to the light diffusion layer, electromagnetic radiation in the form of visible light from the light emitting members is controlled to provide an aura that enhances formed outlines or contours of light around the indicia making up the sign. This illumination system provides a means of illuminating a sign front and therefore light produced by the light emitting members can be wasted due to absorption of particular wavelengths of light by the media being illuminated.

United States Patent Application Publication No. 2005/0028413 discloses a sign for conveying information, having a plastic body, illuminating means such as LEDs mounted in a planar orientation within the body and a reflective coating applied on a surface of the body carrying information to reflect light emitted from the illumination means back into the body of the sign. The sign may have the LEDs mounted to face an inside surface of the sign capable of scattering light to a transparent surface to produce an illuminated area wherein the scattering of the light can produce a substantially even intensity of light across the illuminated area of the sign after its transmission from the sign. Due to the planar arrangement of the light emitting members, light may be wasted during operation of this illuminated sign. Furthermore, this system can also provide a means of illuminating the sign front and therefore light produced by the LEDs can be wasted due to absorption of particular wavelengths of light by the media being illuminated.

U.S. Pat. No. 6,582,103 describes an illumination apparatus which provides an output with high spatial uniformity of luminance. The illumination apparatus includes a cavity that has reflective surfaces and an output area. At least one light source is disposed in the cavity, with the light source includes a point source and an optical diverter having a flared reflecting surface. Light from the point source is distributed by the optical diverter towards the reflective surfaces within the cavity. Before exiting the device, light passes through an optical conditioning element that is positioned over the output area of the cavity. The optical conditioning element includes at least a diffuser, such as a translucent film or plastic sheet, and preferably also includes one or more prism sheets such as a brightness-enhancing film. This configuration of an illumination apparatus produces a substantially even light distribution, however this illumination apparatus may not be capable of illuminating a specific region of the optical conditioning element, which may be desired if a sign is to be viewed as having multiple colours.

U.S. Pat. No. 6,821,007 describes a compact, and low maintenance back lit illuminated sign, wherein such a back lit sign can be suitable for use on a vehicle. The shallow back lit illuminated sign comprises a housing, a light source suitable for supplying light to a light fibre, and at least one side-light emitting fibre. The housing has a sign face and an interior surface that includes a back surface. The sign face has an illuminated area that diffusely transmits light. The back surface is located at a depth from the sign face and may be curved or flat. One or more side-light emitting fibres are connected so as to receive light from the light source and are mounted within the housing so as to limit the amount of emitted light, from the fibres, that travels directly to the sign face. This illuminated sign however, does not provide a means for illuminating different regions of the sign face with different colours or keeping these different colours separated from each other.

U.S. Pat. No. 6,932,495 describes a channel letter lighting unit which comprises a printed circuit board (PCB) having a plurality of linearly mounted light emitting elements. The channel letter lighting units are mounted on a channel letter housing that is planar. This channel letter lighting unit however, does not provide for illuminating different regions of a sign face with different colours or keeping these different colours separated from each other.

U.S. Pat. Nos. 5,542,202 and 6,026,602 describe an internally illuminated sign having indirect illumination provided by LEDs. A plurality of LEDs are mounted on a PCB and mounted within the sign. The PCB is offset to a side of the sign housing with the somewhat directional LED light source directed toward a reflector. The reflector is angled to convert the generally narrow directional light source of an LED into a substantially even, diffused and non-uniform light distribution pattern. This illuminated sign configuration however, is not be capable of illuminating a specific region of the sign, which may be desired if a sign is to be viewed as having multiple colours.

U.S. Pat. No. 6,024,476 describes a sign illuminator wherein a bundle of light conducting fibres are plied to a light diffusing plate having a plurality of recesses which receive the ends of the fibres. The plate is sized and shaped to conform to a channel in the sign so that when the light fibres are inserted into the light diffusing plate their light provides a back illumination for the sign. A light reflecting surface can be placed alongside the interior surface of the light diffusing plate to provide additional light use for the illumination of the sign. This illuminator provides a means of illuminating a sign and therefore light can be wasted due to absorption of particular wavelengths of light by the media being illuminated.

U.S. Pat. No. 6,478,450 describes a light system including a channel sign having lights connected to a flexible conductor strip. The flexible conductor strip is encased between the cover, walls and bottom of the channel sign. This light system configuration however, is not be capable of illuminating a specific region of the sign, which may be desired if a sign is to be viewed as having multiple colours.

Therefore there is a need for a new single or multi-colour sign illumination system that provides the desired level of illumination of a sign while reducing the loss of light energy.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide an integrated sign illumination system. In accordance with an aspect of the present invention, there is provided an integrated sign illumination system for illuminating a sign face, said system comprising: a plurality of light-emitting elements for generation of light having one or more colours; and a contoured mounting device including a plurality of mounting sites, one or more of said plurality of light-emitting elements optically coupled to the contoured mounting device at a selected mounting site, said contoured mounting device configured to direct a selected colour of light to a selected portion of the sign face; wherein said plurality of light-emitting elements are adapted for connection to a power source for activation thereof.

### BRIEF DESCRIPTION OF THE FIGURES

FIG. 1 is an exploded view of a sign comprising an integrated sign illumination system according one embodiment of the present invention.

FIG. 2 is an exploded view of an integrated sign illumination system according to one embodiment of the present invention.

FIG. 3 is a cross sectional view of the integrated sign illumination system illustrated in FIG. 2.

FIG. 4 is a cross sectional view of a portion of the integrated sign illumination system illustrating the relative positioning of a light-emitting element relative to the contoured mounting device.

FIG. 5A is an exploded view of an integrated sign illumination system according to another embodiment of the present invention.

FIG. 5B illustrates a light-emitting module according to one embodiment of the present invention.

FIG. 6 is an exploded view of a sign comprising an integrated sign illumination system according to another embodiment of the present invention.

FIG. 7 is a cross sectional view of the sign of FIG. 6.

FIG. 8 is an exploded view of a sign comprising an integrated sign illumination system according to another embodiment of the present invention.

FIG. 9 is a cross sectional view of the sign of FIG. 8.

### DETAILED DESCRIPTION OF THE INVENTION

### DEFINITIONS

The term “light-emitting element” is used to define any device that emits radiation in any region or combination of regions of the electromagnetic spectrum for example, the visible region, infrared and/or ultraviolet region, when activated by applying a potential difference across it or passing a current through it, for example. Therefore a light-emitting element can have monochromatic, quasi-monochromatic, polychromatic or broadband spectral emission characteristics. Examples of light-emitting elements include semiconductor, organic, or polymer/polymeric light-emitting diodes, blue or UV pumped phosphor coated light-emitting diodes, optically pumped nanocrystal light-emitting diodes or any other similar light-emitting devices as would be readily understood by a worker skilled in the art. Furthermore, the term light-emitting element is used to define the specific device that emits the radiation, for example a LED die, and can equally be used to define a combination of the specific device that emits the radiation together with a housing or package within which the specific device or devices are placed.

The terms “light”, “lighting”, “illumination”, “colour” and “colour of light” are used interchangeably to define electromagnetic radiation of a particular frequency or range of frequencies in any region of the electromagnetic spectrum for example, the visible, infrared and ultraviolet regions, or any combination of regions of the electromagnetic spectrum.

As used herein, the term “about” refers to a ±10% variation from the nominal value. It is to be understood that such a variation is always included in any given value provided herein, whether or not it is specifically referred to.

Unless defined otherwise, all technical and scientific terms used herein have the same meaning as commonly understood by one of ordinary skill in the art to which this invention belongs.

The present invention provides an integrated sign illumination system for the illumination of a sign face. The system comprises a contoured mounting device configured for directing a selected colour of light to a selected portion of the sign face. A plurality of light-emitting elements for the generation of light of one or more colours are optically coupled to the contoured mounting device at selected mounting sites. The colour of the light produced by the light-emitting elements can be configured to be compatible with the selected illumination colour of the sign face thereby providing a means for the reduction of light loss due to absorption by the sign face.

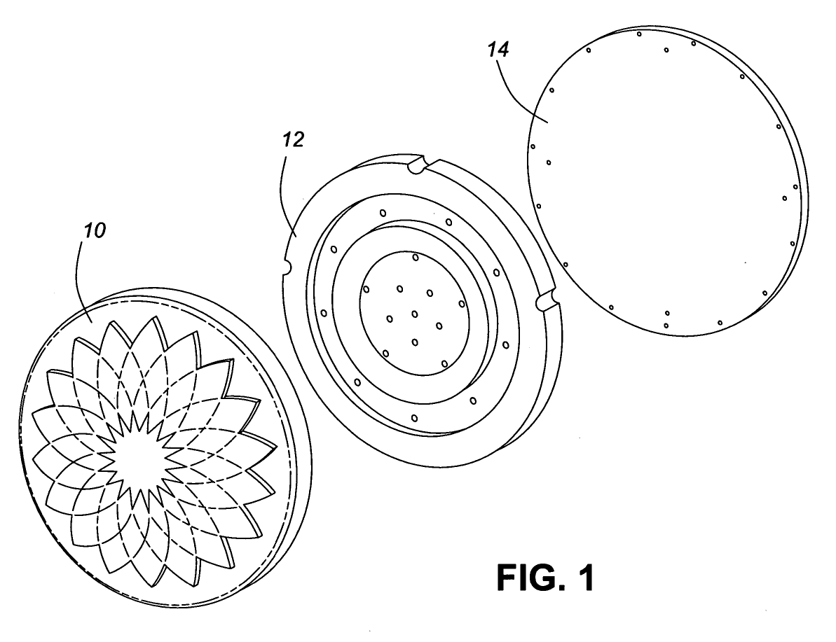

FIG. 1 illustrates a sign comprising an integrated sign illumination system 12 according to one embodiment of the present invention, which is positioned between the sign face 10 and the backing structure 14. The integrated sign illumination system provides a means for the direction of a selected colour of light to a selected portion of the sign face. In order to reduce the amount of light energy lost due to absorption by the sign face, the colour directed to the selected portion of the sign face is compatible with the intended colour to be viewed from the front of the sign face. For example, the colour of the selected portion of the sign face is about the same as the colour of the light generated by the light-emitting elements illuminating the selected portion of the sign face. In this manner energy can be conserved while providing a selected level of illumination of the sign face.

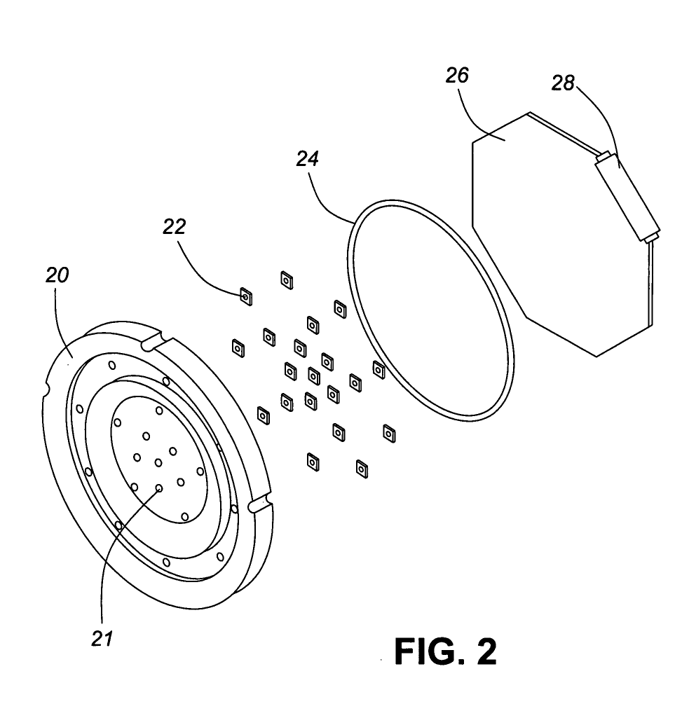

FIG. 2 illustrates an exploded view of an integrated sign illumination system according to one embodiment of the present invention. The contoured mounting device 20 comprises a plurality of mounting sites 21 at which the light-emitting elements 22 are positioned. The contoured mounting device provides a means for strategically positioning the light-emitting elements, for example for a desired colour and illumination of a portion of the sign face associated with the contoured mounting device. Furthermore, one or more light-emitting elements can be positioned at any one mounting site. The contoured mounting device further provides a means for directing selected light generated by the light-emitting elements to predetermined portions of the sign face. The three dimensional shaping of the contoured mounting device can enable the direction or selected light to selected portions of the sign face while impeding the propagation of undesired light to the same selected portion of the sign. The light-emitting elements can be coupled to a heat sink 26, for example a plate, which can provide a means for the coupling of the light-emitting elements to a power supply and control system 28 thereby providing a means for activation thereof, in addition to thermal management of the light-emitting elements.

In one embodiment, the light-emitting elements may be environmentally sealed between the heat sink and the contoured mounting device through the use of a sealing device 24, for example an O-ring or other means of environmental sealing.

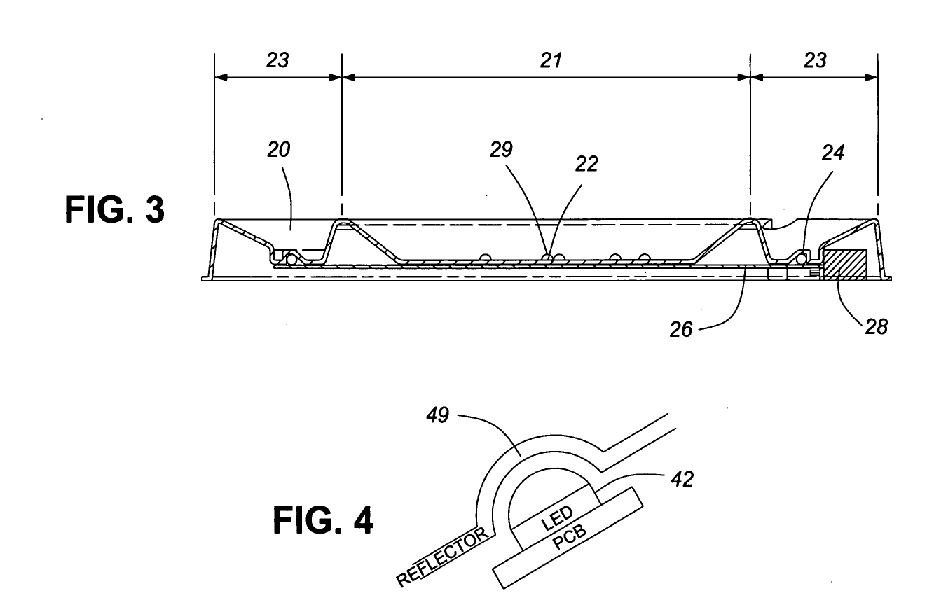

FIG. 3 is a cross sectional view of the integrated sign illumination system illustrated in FIG. 2. One or more of the mounting sites associated with the contoured mounting device can comprise an optical element, for example a lens 29 behind which one or more light-emitting elements are positioned wherein this lens can provide a means for light manipulation and may further provide a means for aiding in the environmental sealing of the light-emitting elements with which it is associated.

In one embodiment of the present invention and with further reference to FIG. 3, the contoured mounting device defines two regions, which are circular in shape. An inner region defined by diameter 21 can be lit using a first colour of light-emitting elements, and an outer ring region of thickness 23, can be lit using a second colour of light-emitting elements. The three dimension shape of the contoured mounting device 20, is designed direct the first colour of light towards the portion of the sign face which can cover the inner region and direct the second colour of light towards the portion of the sign face which can cover outer ring region. Furthermore, this three dimensional shape of the contoured mounting device can limit the propagation of the first light into the outer ring region and the propagation of the second light into the inner region.

In another embodiment, one or more of the mounting sites may be configured as holes or apertures within the contoured mounting device enabling the passage of light therethrough.

In one embodiment of the present invention, the optical element at a mounting site can be configured as a dome shaped lens 49 as illustrated in FIG. 4, and the one or more light-emitting elements 42 may be positioned relative to the dome shaped lens, for example.

In another embodiment of the present invention an optical element can be formed within or coupled to the contoured mounting device, wherein the choice of the optical element can be determined by the selected optical manipulation of the light generated by the one or more light-emitting elements positioned at that mounting site. For example the optical element can be configured to provide reflective, refractive, diffusive, holographic, colour filtering or other form of optical manipulation, as is known in the art.

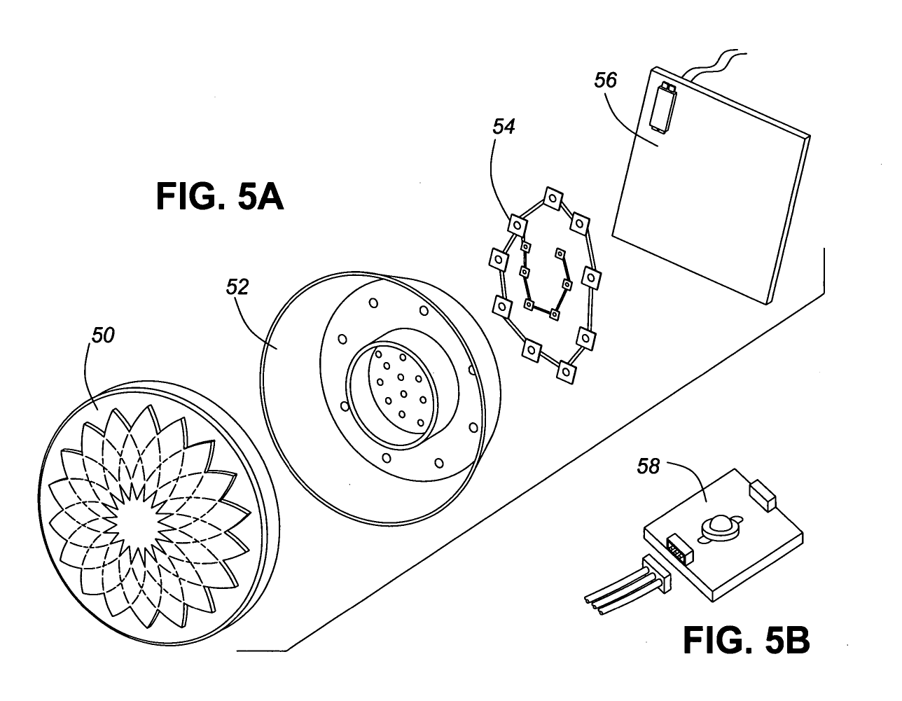

FIG. 5A illustrates an exploded view of another embodiment of the present invention. The sign face 50 is mounted over the contoured mounting device 52 and one or more strings of light-emitting elements 54 are strategically positioned with respect to the contoured mounting device. The string of light-emitting elements can be coupled to a heat sink 56, for example a plate, which can be adapted to provide a means for coupling the light-emitting elements to a power source and to provide thermal management of the light-emitting elements.

FIG. 5B illustrates a light-emitting element module 58, suitable for forming a light-emitting element string. In one embodiment, the string of light-emitting elements 54, as shown in FIG. 5A may be formed from a plurality of light-emitting element modules 58 that can be operatively coupled together, wherein a light-emitting element module can comprise one or more light-emitting elements.

In an alternate embodiment of the present invention, the light-emitting elements or light-emitting element modules can be operatively coupled to a power source and optionally each other, wherein this coupling can be provided by circuit traces that can be located on either or both of the heat sink plate or an appropriate surface of the contoured mounting device, for example.

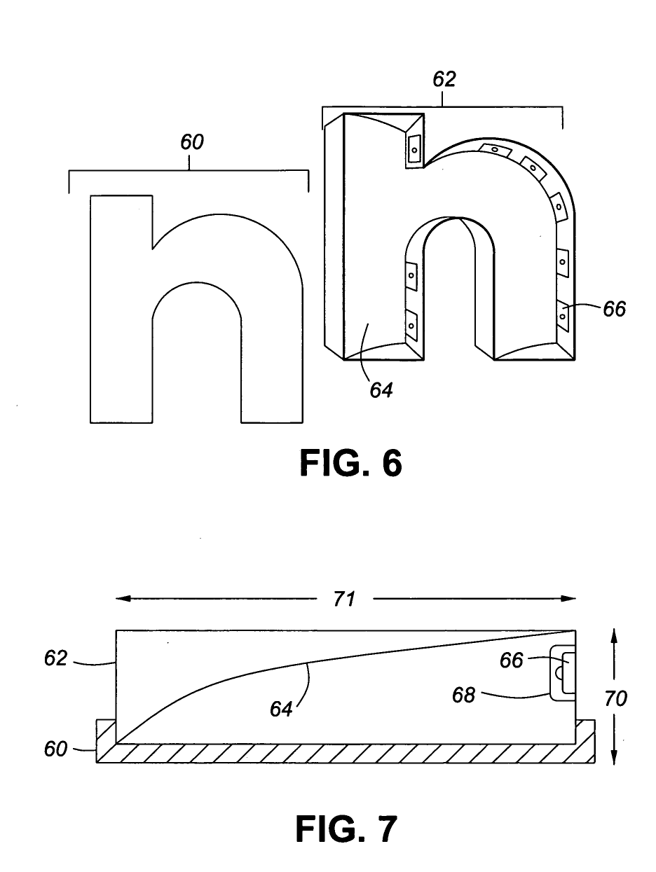

FIG. 6 illustrates a sign comprising a sign face 60 and an integrated sign illumination system 62 according to another embodiment of the present invention. The integrated sign illumination system provides a means for the direction of a selected colour of light to a selected portion of the sign face. In order to reduce the amount of light energy lost due to absorption by the sign face, the colour directed to the selected portion of the sign face can be compatible with or substantially the same as the intended colour to be viewed from the front of the sign face. In this manner energy can be conserved while providing a desired level of illumination of the sign face. In an alternate embodiment, the sign face can be a uniform coloured diffuser. In one embodiment, the sign face can be a frosted “white” diffuser thereby providing for the transmission of almost any colour of light generated by the light-emitting elements.

FIG. 7 shows a cross-sectional view of the sign shown in FIG. 6. In one embodiment, the sign has a small depth 70 in relation to the width 71. In one embodiment the ratio of the depth of the sign to the width of the sign is about 1:2. In another embodiment the ratio of the depth of the sign to the width of the sign is about 1:3. In still another embodiment the ratio of the depth of the sign to the width of the sign is greater than or equal to about 1:5. In the configuration shown in FIG. 7, the lighting-emitting elements 66 can be strategically positioned with respect to the contoured mounting device 64, for example in order to achieve a desired illumination level of a particular region of the sign face associated with contoured mounting device. The lighting-emitting elements 66 may have an optical lens 68 associated therewith to provide collimation of the light generated thereby. The contoured mounting device is configured as a three dimensional reflector and can be designed to be optically active. For example, walled portions of the contoured mounting device 64 can provide for the reflection of the light generated by the light-emitting elements. In one embodiment the contoured mounting device 64 can be fabricated from a reflective material or can alternately be coated with a reflective material, for example. In another embodiment of the present invention, the contoured mounting device can be coated with phosphor.

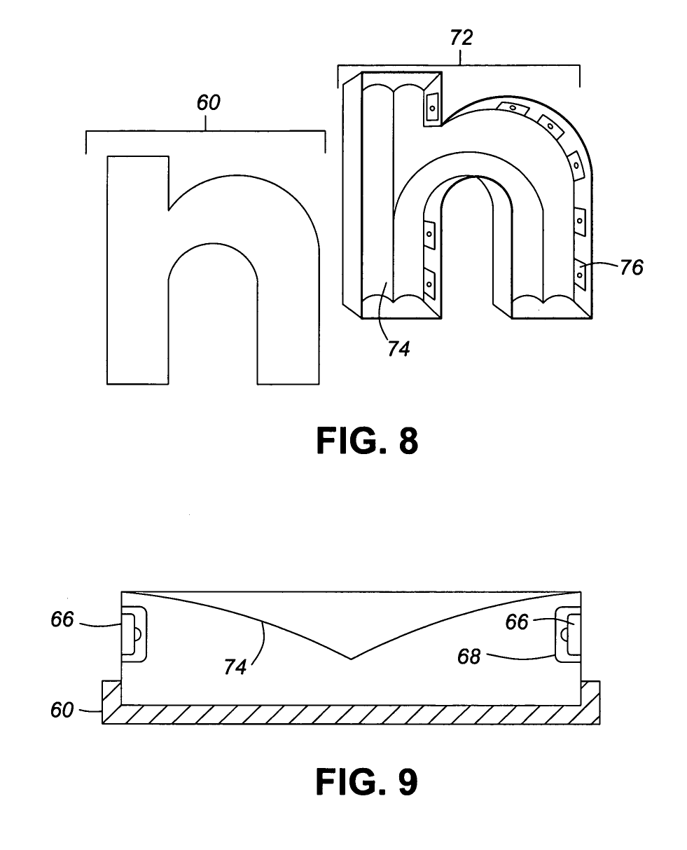

FIG. 8 illustrates a sign comprising a sign face 60 and an integrated sign illumination system 72 according to another embodiment of the present invention. The light-emitting elements 66 can be strategically positioned, with respect to the contoured mounting device 74, in order to take advantage of another three dimensional configuration of the contoured mounting device. FIG. 9 illustrates a cross sectional view of the embodiment illustrated in FIG. 8.

Contoured Mounting Device

The contoured mounting device provides for the direction of a selected colour of light towards a selected portion of the sign face. In this manner, the colour of light can be strategically selected for energy conversation, when compared with using white light and relying on the absorption of unwanted colours of light by the sign face, in order for the selected colour to emanate from the sign face.

In one embodiment, the contoured mounting device is three dimensional in format and can be designed to be optically active. For example, walled portions of the contoured mounting device can provide for the reflection of the light generated by the light-emitting elements. The contoured mounting device can be fabricated from a reflective material or can alternately be coated with a reflective material, or phosphor for example.

In one embodiment, the contoured mounting device is designed to substantially optically separate the sign face into regions, wherein a region may be a portion of the sign face where a particular colour is to emanate therefrom. In this manner the contoured mounting device can enable the reduction of interference or “cross talk” between different colours of light that are used to illuminate a multicoloured sign face.

The contoured mounting device can provide for the consistent placement and positioning of light-emitting elements relative to a sign face, thereby providing for a more effective and desired illumination pattern being generated for the sign face. This can additionally provide a means for fabrication consistency across a plurality of integrated sign illumination systems.

In one embodiment, the contoured mounting device can provide for the three dimensional placement of the light-emitting elements, thereby providing a means for further modification of the light being projected towards the sign face. Alternately the light-emitting elements can be provided in a planar setup relative to the contoured mounting device.

In one embodiment of the present invention, the sign face comprises a plurality of colours and the contoured mounting device provides for the strategic placement of selected coloured light-emitting elements in predetermined positions, while substantially isolating one or more colours from other colours. In this manner, selected colours of light can be directed to selected portions of the sign face.

In one embodiment of the present invention, the sign face is three-dimensional in configuration and the contoured mounting device can be configured to mimic this three dimensional shape. In this manner the three-dimensional sign face can be illuminated evenly as the distance from a light-emitting element coupled to the contoured mounting device can be substantially uniform across the across the sign face.

In an alternate embodiment, when an uneven illumination pattern is desired, the shape of the contoured mounting device can be configured to vary from that of the sign face, thereby altering the distance between the light-emitting elements and the sign face over the surface area of the sign face. In this embodiment, first portions of the sign face wherein the distance from the light-emitting elements to the sign face is greater may appear washed out when compared to second portions of the sign face wherein the distance from the light-emitting elements is smaller.

In one embodiment of the present invention, the contoured mounting device can provide for the adjustment of the correlated colour temperature of a specific region of a sign face. This can be enabled by defining a spatial region by the shape of the contoured mounting device together with the placement of a variety of colours of light-emitting elements within this region. Through appropriate control of the variety of colours of light-emitting elements colour changing capabilities of that region of the sign face can be provided.

The shape of the surface of the contoured mounting device can be any desired shape, for example contoured mounting device can be configured with vertical walls, sloped walls, curved walls, parabolic walls or any other shape. In addition the surface of the contoured mounting device can be configured to provide for random reflection of light emanating from the light-emitting elements. For example the surface of the contoured mounting device can be roughened thereby providing random reflection of light.

In one embodiment of the present invention, the contoured mounting device can be configured to provide the ability to adjust the correlated colour temperature of a specific region of a sign face. This functionality can be enabled by providing a coloured reflective material or coating on the contoured mounting device. For example, to create consistent white light using light-emitting elements with varying correlated colour temperature (CCT), the contoured mounting device can be coated with a shade of blue material to create a “cool” white, or it can be coated with a pink material to create a “warm” white.

Light-Emitting Elements

The light-emitting elements associated with the integrated sign illumination system according to the present invention, provide the selected light for illumination of the sign. In one embodiment the light-emitting elements are configured to produce a particular colour of light.

In an alternate embodiment, light-emitting elements, which generate red light, green light or blue light can be strategically positioned relative to each other in a manner such that the combination of this red, green and blue light can provide a means for generating white light or any other colour of light in the colour gamut. This configuration light-emitting elements can additionally provide a means for adjusting the blended colour of the light produced.

In one embodiment of the present invention, a light-emitting element or group of light-emitting elements has an optical device which is optically coupled thereto. This optical device can provide a means for manipulating the light generated by the light-emitting elements with which it is associated. For example the optical member may diffuse, collimate, reflect, refract or blend the light emitted by the one or more light-emitting elements associated therewith.

In one embodiment of the present invention, an optical lens which is optically coupled to one or more light-emitting elements, can be tinted with a pigment to provide for the adjustment of the correlated colour temperature (CCT) of a specific region of a sign face. For example, to create consistent white light using LED sources with varying CCT the optical lens can be tinted blue to create a “cool” white, or it can be tinted pink to create a “warm” white. The amount of pigment and thickness of the lens will determine the degree of the color adjustment to the sign face.

In one embodiment of the present invention, the light-emitting elements and their respective circuitry can be coated with a conformal coating, for example a spray or other environmental protection coating. In this embodiment, the contoured mounting device may not necessarily be required to provide environmental protection to the light-emitting elements.

The embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1. An integrated sign illumination system for illuminating a sign face, said system comprising:
a) a plurality of light-emitting elements for generation of light having one or more colours; and
b) a contoured mounting device including a plurality of mounting sites, one or more of said plurality of light-emitting elements optically coupled to the contoured mounting device at a selected mounting site, said contoured mounting device configured to direct a selected colour of light to a selected portion of the sign face;
wherein said plurality of light-emitting elements are adapted for connection to a power source for activation thereof.

2. The integrated sign illumination system according to claim 1, wherein the contoured mounting device is shaped to optically separate the sign face into two or more regions, a first of the two or more regions emanating light of one or more first colours and a second of the two or more regions emanating light of one or more second colours.

3. The integrated sign illumination system according to claim 1, wherein one or more of the mounting sites includes an optical element for manipulating light emitted by one or more light-emitting elements.

4. The integrated sign illumination system according to claim 3, wherein the optical element is configured to have one or more of the properties selected from the group comprising reflective, refractive, diffractive, holographic and colour filtering.

5. The integrated sign illumination system according to claim 3, wherein the optical element is a lens.

6. The integrated sign illumination system according to claim 1, wherein one or more of the mounting sites are apertures within the contoured mounting device.

7. The integrated sign illumination system according to claim 1, wherein the contoured mounting device includes wall portions.

8. The integrated sign illumination system according to claim 7, wherein one or more of the wall portions are shaped as vertical walls, sloped walls, curved walls, parabolic walls.

9. The integrated sign illumination system according to claim 1, wherein the contoured mounting device has a surface and the surface is coated with one or more of a reflective material or a phosphor.

10. The integrated sign illumination system according to claim 1, wherein the contoured mounting device is fabricated from a reflective material.

11. The integrated sign illumination system according to claim 1, wherein the contoured mounting device has a surface and the surface is a roughened reflective surface.

12. The integrated sign illumination system according to claim 1, wherein the selected colour of light and the selected portion of the sign face are similar colour.
